(19) United States
(12) Patent Application Publication
(10) Pub. No.: US 2014/0328639 A1
(43) Pub. Date: Nov. 6, 2014

(54) Adjusting Adjustable Tools Clamped on a Motor Spindle of a Machine Tool

(71) Applicant: ARTIS GmbH, Bispingen-Behringen (DE)

(72) Inventor: Albert Hofmann, St. Leon-Rot (DE)

(73) Assignee: ARTIS GmbH, Bispingen-Behringen (DE)

(21) Appl. No.: 14/268,901

(22) Filed: May 2, 2014

(30) Foreign Application Priority Data
May 2, 2013 (DE) 102013208027.1

(51) Int. Cl. B23Q 5/04; B23Q 11/12

(52) U.S. Cl. CPC B23Q 5/04; B23Q 11/127
USPC 408/1 R; 408/124; 408/56; 408/126

(57) ABSTRACT

The invention refers to a motor spindle for a machine tool which includes a tool clamping system configured to automatically clamp and release an adjustable tool, a control rod arranged within the tool clamping system, and a setting unit arranged at a B side of the motor spindle which is configured to adjust an adjustable tool via the control rod.

### PRIORITY CLAIM

This application claims benefit of priority of German application no. 102013208027.1 titled “Method and Apparatus for Adjusting Adjustable Tools Clamped on a Motor Spindle of a Machine Tool”, filed May 2, 2013, and whose inventor is Albert Hofmann.

### INCORPORATED BY REFERENCE

German application no. 102013208027.1 titled “Method and Apparatus for Adjusting Adjustable Tools Clamped on a Motor Spindle of a Machine Tool”, filed May 2, 2013, and whose inventor is Albert Hofmann, is hereby incorporated by reference in its entirety as though fully and completely set forth herein.

### TECHNICAL FIELD

The present invention refers to an apparatus and a method for adjusting adjustable tools clamped on a motor spindle of a machine tool.

### DESCRIPTION OF THE RELATED ART

Nowadays, high requirements are put on the profitability and the productivity of production plants. Machine tools are key elements in many production plants. Modern machine tools often have motor spindles. A motor spindle is a shaft directly driven by an electric motor which has an integrated tool interface.

In order to fulfil the challenges in an automated flexible production with respect to productivity automatic tool clamping systems are already used since some time. Examples of automatic clamping systems are described in the European patent EP 0 339 321 B1 and in the published patent application DE 10 2005 008 892 A1. The patent DE 10 2010 009 664 B4 discloses a signal processing unit which allows to monitor a motor spindle and with which in particular a measure for a deviation of the motor spindle and/or its bearing from a target state can be determined.

For more and more processing steps it is necessary to cool and to lubricate the tool, in order to secure the quality (dimensional accuracy, surface quality, durability, etc.) of the processing process. This is best secured in that the respective tools have fine bores through which the coolant and lubricant is directly provided at the operating place.

Typically, the tools as well as the tool cutting edges are simultaneously cleaned from chips by the cooling means. Moreover, automatic clamping systems have a separate supply for cleaning air in order to keep the tool holder at the spindle side clean during a tool exchange.

For fine processing processes and/or special processing processes, as for example recesses, adjustable or actuating tools have to be used. For adjustable tools, the tool cutting edges can be extended and retracted in a defined manner. For presently available adjustable tools for fine processing processes the actuating adjustment is often directly build into the tool. For example, the patent EP 1 169 154 B1 discloses the piezo-electric adjustment element arranged in tool for very fine processing for setting a cutting element. The patent DE 199 25 193 B4 describes a holding mechanism to hold a piezo-electric adjustment element in a defined deformation state of the tool so that it is possible to operate the tool without an external power supply.

It is necessary to provide for different fine processing processes a multitude of different tools, thus the installation of an actuating adjustment element in each tool leads to enormous costs. Furthermore, this leads to adjustable tools having a large size and a large weight. Moreover, the supply of electrical power to an actuating adjustment element rotating in the tool is susceptible to dirt and humidity, and thus can only be performed in a sophisticated manner; nevertheless, the power supply of adjustment tools rotating in a tool are prone to wear and prone to error.

The patent EP 0 491 724 B1 discloses a tool head for the application in machine tools. The machine tool comprises a slider which is rotatable perpendicular to the rotation axis and can be inserted in different cutting tools. The published patent application DE 10 2011 080 701 A1 describes a clamping mechanism for the slider which avoids an unintended shift of the slider during the operation of the tool head in a fast rotating motor spindle. The brochure KOMET KomTronic® U-Achssysteme, which can be downloaded from the homepage of the company Komet, describes a modular system which comprises an electrical drive with a machine interface onto which block tools can be clamped if necessary with the help of adapters.

The brochure MAPAL TOOLTRONIC®, which can be downloaded from the homepage of the company Mapal, presents a modular system of different actuating tools for processing of arbitrary recesses and non-cylindrical bores. The modular system also has its own electrical drive which has again a machine interface for clamping onto a motor spindle and a modular interface at the tool side. Different actuating tools can be clamped on the modular interface and the different snap-on tools can be clamped to the actuating tool.

Both modular approaches avoid the installation of an own drive unit into each adjustable tool. However, only very specific tools can be clamped or flanged to the drive unit or the tool head, respectively. Moreover, the tools have to be manually inserted in the actuating tool or the slider, respectively.

The European patent EP 0 430 984 B1 describes a fine boring machine with an adjustable tool which is radially deflected by a piezo-electric actuator which is arranged in the working spindle of the fine boring machine, and wherein the piezo-electric actuator mechanically shifts a drawbar. The tool can manually be exchanged.

Thus, the principle disclosed in the EP 0 430 984 B1—similar to the above mentioned modular approaches—avoids the installation of an actuating adjustment unit in each adjustable tool. However, the power supply of the actuator rotating in the working spindle has still the above discussed drawbacks. Moreover, each tool has to be manually clamped on the working spindle of the fine boring machine.

The present invention is therefore based on the problem to provide an apparatus, a method and externally controllable adjustable tools which can automatically be clamped onto a motor spindle of a machine tool.

### SUMMARY OF THE INVENTION

According to a first aspect of the invention this problem is solved by an apparatus according to an exemplary embodiment. The apparatus may include a motor spindle for a machine tool that may include (a) a tool clamping system adapted to automatically clamp and release an adjustable tool; (b) a control rod arranged within the tool clamping system; and (c) a setting unit arranged on the B side of the motor spindle and adapted to adjust the adjustable tool via the control rod.

The inventive apparatus allows adjustable tools to clamp via an automatic tool clamping system, and thus to meet the repeatability required for a series production. A control rod of an inventive apparatus does not need any space for its installation in an automatic tool clamping system on the A side of a motor spindle. The setting unit flanged at the B side the motor spindle does not extend in radial direction beyond the dimensions of the motor spindle. Thus, the combination of a control rod and a setting unit allows automatically adjusting adjustable tools without essentially impairing the compact setup of a motor spindle. Thus, the small size of the setting unit flanged at the B side of the motor spindle allows realizing very small actual dimensions in machine tools having several spindles. The above described control rod and setting unit can simply be integrated in the designs of existing motor spindles.

The tool cutting edges of adjustable tools can be adjusted with a precision in the range of micrometers via the motor spindle according to embodiments. The wear of a cutting edge and/or the length extensions caused by heating can be compensated in a closed control loop. If necessary, the tool cutting edges can simultaneously be lubricated and/or cooled. Thus, an inventive apparatus allows the execution of contour machining processing processes, as for example the processing of cones and the fabrication of trumpet shapes to only mention two examples.

In general, the quality of a processing process primarily depends on the quality of the tool, i.e. its tolerances, the cutting parameters of the tool, and the preciseness of the drilling spindle. Due to its bearing and its direct drive the design of a drilling spindle in form of a motor spindle fulfils highest preciseness requirements with respect to the position and the angular position of the spindle shaft. On this basis, an inventive apparatus allows to automatically and very precisely clamp adjustable tools. Thus, the inventive apparatus is predestined for the application in an automatic manufacture.

According to a further aspect, the control rod has a drilled hole in axial direction to conduct at least one fluid through the control rod. According to a further aspect, the at least one fluid comprises a coolant, a gas or a gas mixture, in particular air and/or an oil.

By conducting the fluid through a drilled hole of the control rod, the already mentioned lubrication and/or cooling of the adjustable tool can be realized. The fluid used for cooling and/or lubrication additionally removes chips from the processing site. Alternatively, the processing site, i.e. the tool can be cleaned through the drilling hole of the control rod via compressed air.

In another aspect, the setting unit comprises at least one electric motor and at least one worm gear. According to a further aspect, the at least one worm gear comprises a planetary gear. In a beneficial aspect, the at least one electric motor comprises at least one actuator and the setting unit further comprises a clutch to couple the at least one worm gear to the actuator. In a preferred aspect, the at least one electric motor moves the control rod in axial direction via the at least one worm gear in order adjust the adjustable tool.

According to a further aspect the setting unit controls the tool side end of the control rod after an electronic request of the axial position of the control rod with a mean deviation of ≦±100 μm, preferred ≦±50 μm, more preferred ≦±20 μm and most preferred <±10 μm from a predetermined nominal position.

The above mentioned adjustment accuracy of the tool cutting edges in the micrometer range is achieved by an essentially free of play transmission of the rotational movement of the rod of the actuator in a translational movement of the control rod by a planetary gear. If there is a clutch between the actuator and the worm gear, the clutch also has an essentially free of play construction. The term “essentially” means here as well as in other passages in this description a deviation from a nominal value which is within predetermined tolerance limits.

Via a closed control loop the axial position of the tool-side end of the control rod can be retrieved, and thus the cutting edges of the tool can be adjusted with an accuracy in the micrometer range.

According to still another aspect, the setting unit comprises a cooling unit. According to a further aspect, the cooling unit comprises a rotatory feed-through. In an advantageous aspect, the cooling unit adjusts the adjustable tool via the fluid conducted through the at least one control rod.

It is an essential advantage of the defined apparatus that it can both adjust mechanically adjustable tools and fluid or media controlled tools. Thus, the defined apparatus is best suited for the application in an automated flexible manufacture, since it allows the use of already available adjustable tools. Fixedly executed tools, i.e. tools whose tool cutting edge cannot be adjusted, can of course be clamped to the above defined motor spindle.

According to a further beneficial aspect the at least one tool cools and/or lubricates the adjustable tool. According to a further beneficial aspect an axial movement of the control rod adjusts the adjustable tool and the at least one fluid cools and/or lubricates the adjustable tool.

The defined motor spindle offers the possibility to precisely adjust two different parameters, and thus independent from each other the tool cutting edges of the adjustable tool and to cool and/or lubricate a tool which is designed for this purpose with a predetermined quantity of a fluid in a defined way.

In a further aspect a method for adjusting an adjustable tool which is detachably connected to a motor spindle of a machine tool has an automatic tool clamping system arranged in a motor spindle and the tool clamping system comprises a control rod which is arranged within the automatic tool clamping system. The method comprises the steps of: (a) clamping and releasing an adjustable tool via an automatic tool clamping system; and (b) adjusting the adjustable tool via a setting unit arranged on the B side of the motor spindle via a control rod.

The inventive method allows to automatically clamp and to automatically control adjustable tools of the motor spindle from the B side. Thus, the design of the tools is not restricted.

According to a further aspect, adjusting the adjustable tool comprises moving the control rod in axial direction. In a further beneficial aspect, moving the control rod in axial direction comprises transforming a rotational movement of a shaft of an electric motor into a translational movement of the control rod by a worm gear, in particular a planetary gear.

In a further preferred aspect, adjusting the adjustable tool comprises conducting a fluid through a drilling hole of the control rod in axial direction. According to still another aspect, adjusting the adjustable tool comprises moving the control rod in axial direction and cooling and/or lubricating of the adjustable tool via conducting a fluid through a drilling hole of the control rod in axial direction.

According to a second aspect, the problem of the present invention is solved by an apparatus according to another exemplary embodiment. The apparatus may include an adjustable tool that may include (a) a receiving part adapted to detachably engage with an automatic tool clamping system; and (b) a power transmission element adapted to detachably engage with a control rod arranged in the automatic tool clamping system in order to adjust the adjustable tool.

Adjustable tools which have a power transmission element and thus can be mechanically controlled via a translational movement of a control rod of the above defined apparatus enable the setup of a modular system of adjustable tools for an automated and flexible manufacture.

In still another preferred aspect, the power transmission element is further adapted to receive a fluid which is provided to the tool by an axial drilling hole of the control rod.

A tool designed in this manner has two different parameters which allow to independently adjust the tool cutting edges of adjustable tools and to define the supplied amount of coolant/or lubricant at the processing site.

Finally, in a further beneficial aspect, an adjustable tool comprises at least one spring adapted to counteract a force which is exerted by the power transmission element.

In an adjustable tool of the prior art the control rod is fixedly connected with a tool and can generate a force acting in axial direction which is directed in the direction of the tool (push) or which is directed in the direction of the B side (pull). For an exchangeable tool, i.e. in particular at an automatically clampable tool, the control rod can only push on the power transmission element of the adjustable tool, however cannot exert a tensile force on the power transmitting element. A spring installed in the tool provides a force which counteracts the force of the control rod and thus allows a defined adjustment of the tool cutting edges of the tool.

### BRIEF DESCRIPTION OF THE DRAWINGS

In the following, detailed description presently preferred embodiments of the present invention are described with respect to the accompanying figures, wherein

FIG. 1 illustrates a schematic representation of a motor spindle with an integrated automatic tool clamping system which clamps an adjustable tool and a setting unit for adjusting or setting an adjustable tool;

FIG. 2 represents an example of a motor spindle for automatically clamping and adjusting adjustable tools;

FIG. 3 represents an enlarged view of the B side of the motor spindle of the example of FIG. 2;

FIG. 4 shows an enlarged view of the A side or the tool side of the motor spindle of FIG. 2 with an inflexible, i.e. not adjustable tool;

FIG. 5 represents an enlarged view of the tool side of the motor spindle of FIG. 2 with a first adjustable tool;

FIG. 6 shows an enlarged view of the tool side of the motor spindle of FIG. 2 with a second adjustable tool; and

FIG. 7 represents an enlarged view of the A side of the motor spindle of FIG. 2 with a third adjustable tool.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

In the following, presently preferred realization examples of the inventive apparatus and of the inventive method for automatically clamping an adjustable tool onto a motor spindle of a machine tool are explained. These exemplary explanations are described in the context of a motor spindle for a machine tool. Due to their bearings and their direct drives motor spindles are especially well suited for fine processing processes. However, an apparatus described here can also be applied in spindles of different types of machine tools.

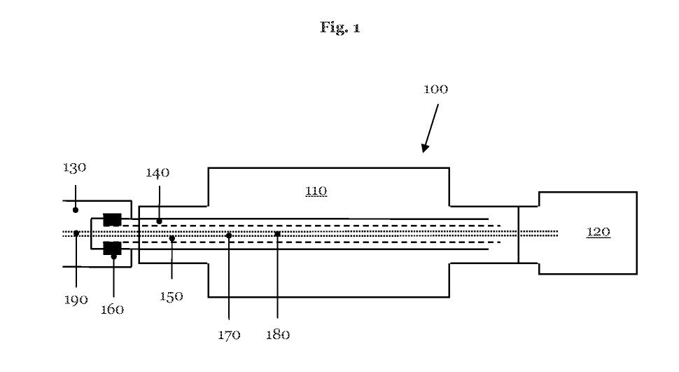

FIG. 1 schematically shows an over view of an inventive apparatus 100. The inventive apparatus 100 comprises a motor spindle 110. The A side indicates the side of the motor spindle 110 which carries a tool. The B side describes the opposite end of the motor spindle 110. A setting unit 120 is flange-mounted at the B side of the motor spindle 110. A spindle shaft 140 is arranged in the motor spindle 110. A tool 130 is clamped on the spindle shaft 140 of the motor spindle 110 on the A side of the motor spindle. The spindle shaft 140 extends from the bearing on the B side to the tool interface on the A side. Common types of tool interfaces are for example HSK (hollow shank taper) or SK (steep taper). The inventive apparatus can be used for both tool interfaces as well as for further tool interfaces whose tool clamping system allow a central axial access.

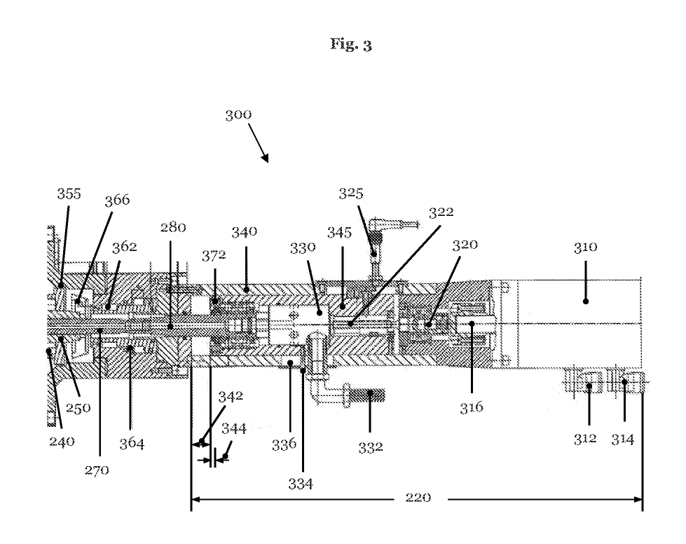

The spindle shaft 140 comprises an automatic tool clamping system 150 or an automatic tool clamping device 150. The tool clamping device 150 comprises collet chucks 160 on the A side by which the tool 130 can automatically be clamped and released from the spindle shaft 140 of the motor spindle 110. On the B side the tool clamping device 150 extends beyond the spindle shaft 140 in order to attach at the extending part a clamping and releasing apparatus. Details are discussed below in the context of FIG. 3.

At the moment, automatic tool clamping systems 150 are available in the market which use different principles for clamping and releasing tools 130. The clamping process and the releasing process are independent from whether a tool 130 is adjustable or not. The apparatus 100 described here is independent from the kind of the clamping system 150. Rather, the described apparatus 100 can be used for all presently available and future automatic tool clamping systems 150 which have a central axial opening.

A control rod 170 is arranged in the tool clamping device 150. The control rod 170 extends from the tool interface of the spindle shaft 140 to the setting unit 120. The control rod 170 has an axial drilling hole 180 which also extends from the setting unit 120 to the tool interface on the A side of the motor spindle 110. The channel 190 of the tool 130 can be supplied with coolant and/or lubricant via the drilling hole 180 of the control rod 170.

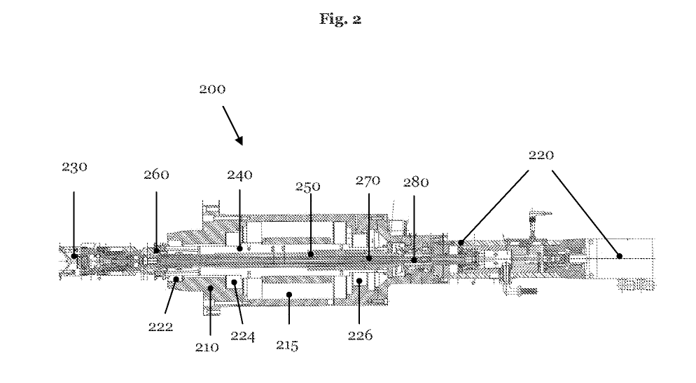

FIG. 2 shows at a glance a realization example 200 of an apparatus for automatically clamping and adjusting adjustable tools. The motor spindle 210 has a spindle shaft 240. The spindle shaft 240 is fixed in its position on the A side by the bearings 222 and 224 and on the B side by the bearing 226. The stator 215 drives the spindle shaft 240. The spindle shaft 240 comprises an automatic tool clamping system 250 which has collet chucks 260 on the B side. A control rod 270 which has a continuous axial drilling hole 280 is located in the tool holder 250. A tool 230 is clamped on the spindle shaft 240 of the motor spindle 210 on the A side. The setting unit 220 is flange-mounted on the B side of the motor spindle 210.

FIG. 3 shows an enlarged cut out of the B side of the motor spindle 210 with the flange-mounted setting unit 220. The setting unit 220 comprises an actuator 310 at its right end which is provided with electrical power via the connections 312 and 314 and comprises a housing setting unit 340. The shaft 316 of the actuator 310 is connected to the planetary gear spindle 320. The planetary gear spindle 320 is connected to the screw nut 322. The screw nut 322 of the planetary gear spindle 320 is arranged in a piston 345 of the housing setting unit 340, wherein the piston 345 is moveable in axial direction. A rotary feed-through 330 is also arranged in the moveable piston 345. The axial control gear, which comprises in the example of FIG. 3 the planetary gear spindle 320 and the screw nut 322, transforms the rotational movement of the shaft 316 of the actuator in a translational movement of the control rod 270. The maximum stroke 342 of the control rod 270 is 26 mm in the example represented in FIGS. 2 and 3. A rotation of the shaft 316 corresponds to an axial translational movement of the control rod of 2 mm. A reserve 344 of 5 mm is foreseen for wear compensation which is contained in the maximum stroke of 26 mm.

The proximity switch 325 serves as a reference point sender unit for the absolute value transmitter of the actuator 310 which is retrieved when the machine tool is started. The current position of the control rod 270 is calculated via the data of the absolute value transmitter of the actuator 310.

The left end of FIG. 3 presents the end 355 of the spindle shaft 240. The tool clamping device 250 is arranged in the spindle shaft 240. The hydraulic unit 364 which is connected to the automatic tool clamping device 250 serves for automatically clamping and releasing the tool 130, 230 via the hydraulic piston 362 by shifting the tool clamping device 250 in axial direction.

As already mentioned above, the control rod 270 has a continuous axial drilling hole 280. The drilling hole 280 is connected to the rotary feed-through 330. The passage of the rotary feed-through 330 to the control rod 270 is sealed by a seal ring. A fluid can be provided to the rotary feed-through via the connection 332. In this description the term fluid comprises coolants, lubricants, oils and gasses or gas mixtures for adjusting fluid controlled tools as well as generally for cooling, lubricating and cleaning the tools 130, 230 or the tool cutting edges of the tools 130, 230. Presently, air is typically used as coolant and for cleaning the tools 130, 230.

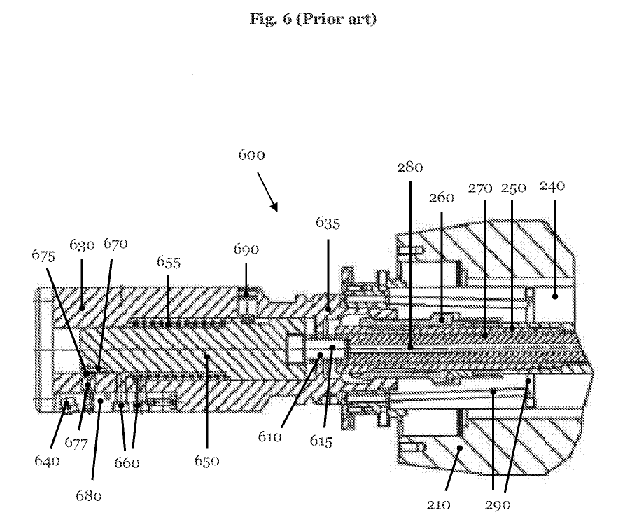

Thus, the tool can be supplied with respective lubricants and/or coolants in a control manner via the drilling hole 280 of the control rod 270. Adjustable tools 130, 230 controlled by fluid can be controlled or adjusted by adjusting a respective pressure at the connection 332 of the rotary feed-through 330 independent from an axial translational movement. Details are explained in the context of the discussion of FIG. 6. The term tools controlled by fluid means in this description the adjustment or setting of cutting edges of adjustable tools by the provision of a defined quantity of a fluid to the tool per time unit.

The rubber seal 336 of the housing setting unit 340 covers the access to the movable piston 345 and avoids the penetration of dirt on the moveable piston 345 of the housing setting unit 340. The leak tightness of the rotary feed-through 330 can be checked via the leakage connection 334. Instead of coolant or lubricant, the tool 130, 230 can alternatively be supplied also with compressed air or cleaning air for cleaning the processing side via the connection 332.

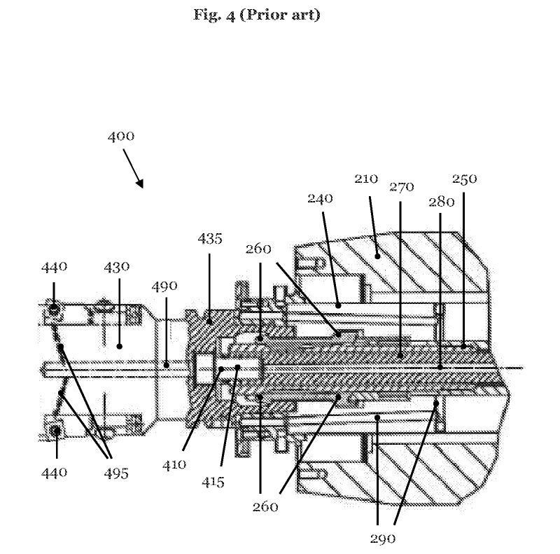

The arrangement 400 of FIG. 4 shows the A side of the motor spindle 210 of FIG. 2. The motor shaft 240 of the motor spindle 210 carries a tool 430 according to the prior art. The collet chucks 260 of the tool clamping device 240 arranged in the spindle shaft 240 clamp the tool 430 on the spindle shaft 240 of the motor spindle 210.

The spindle shaft 240 has drilling holes or openings 290. The openings 290 end at the inner cone and at the front side of the tool holder of the spindle shaft 240. After releasing the collet chucks 260, the control rod 270 carries on in the direction of the tool 430 and mechanically pushes the tool 430 from the spindle shaft 240.

The control rod 270 ends in a connection part or a power transmission element 410 which is arranged in the shaft or receiving part 435 of the tool 430. The connection element 410 has a channel 415 which is connected to a channel 490 available in the tool 430. The cutting edges 440 of the tool 430 are supplied with coolant and/or lubricant via the openings 495 which are connected to the channel 490. The tool 430 is an example of an inflexible tool, i.e. the tool cutting edges 440 cannot be adjusted or can at least not automatically be adjusted. The passage of the control rod 270 to the power transmission portion 410 of the tool 430 is sealed via a seal ring (not represented in FIG. 4).

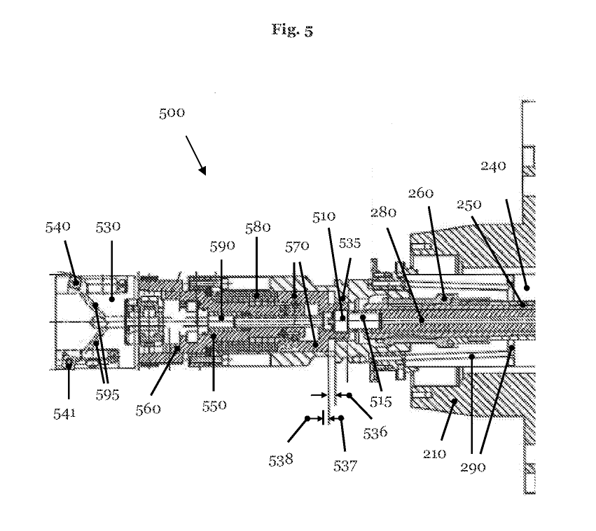

The configuration 500 of FIG. 5 represents again the A side of the motor spindle 210 of FIG. 2. In the example represented in FIG. 5, the tool 530 which is adjustable or controllable during a processing process is clamped on the spindle shaft 240 of the motor spindle 210. The adjustable tool is a drilling tool. The connection part or power transmitting part 510 of the tool 530 is again connected to the control rod 270. Similar as explained in the context of FIG. 4, the channels or openings 590 and 595 of the tool cutting edges 540 of the tool 530 can provide coolants and/or lubricants in a defined manner via the connection 332 of the rotary feed-through 530, the drilling hole 280 of the control rod 270 to the channel 515 of the power transmission element 510. As already explained during the discussion of FIG. 4, the passage of the control rod 270 to the power transmission element 510 of the tool 530 is sealed via a seal.

The tool 530 further comprises a fork 570 and an adjusting head 560. A preloaded spring assembly 580 shifts the fork 570 in the direction of the spindle shaft 240. Instead of a spring or a spring assembly, for example a pneumatic pressure unit can also be used. The position of the fork 570 is illustrated in FIG. 5 by the reference number 537. In the position 537, the tool cutting edge 545 of the tool 530 is retracted. The adjusting head 560 can be adjusted by bending the inner tool part 550 via a translation movement of the control rod 270. For a rough drilling process the fork 570 of the tool 530 is shifted with a stroke 538 of up to 5 mm from the shaft of the tool part 550 against the force of a preloaded spring assembly 580. This shift is symbolized in FIG. 5 by the reference number 538. The bending of the inner tool part 550 leads to a radial setting of the tool cutting edge of the tool 530 in a direction away from the rotation axis. In this state 538, i.e. with extended tool cutting edge 541 of the tool 530 rough drilling processes are executed (semi finish drilling).

For fine drilling or for finish-drilling the control rod 270 is retracted up to 5 mm, i.e. is moved in the direction towards the B side. As a consequence of which the spring assembly 580 shifts the fork 570 towards the spindle shaft 240 and the bending of the inner tool part 550 is reversed. Thus, the tool cutting edge 541 of the tool 530 returns to its starting position 540.

The spring or the spring assembly 580 of the tool 530 of FIG. 5 provides the tensile force of the control rod which is missed in the automatically clampable tool due to the loose coupling of the control rod 270 to the power transmission element 510. The externally controllable and automatically clampable tool 530 shown in FIG. 5 operates essentially without play. The tool 530 achieves a repeatability in the micrometer range.

A shift 536 of approximately 5 mm is again foreseen between the shaft or the receiving part 535 of the tool 530 and the fork 570 in order to compensate the tool wear.

The arrangement 600 of FIG. 6 shows again the tool side of the motor spindle 210 of FIG. 2. In the example of FIG. 6, an adjustable tool 630 of the prior art is clamped on the spindle shaft 240 of the motor spindle 210 for a fine processing process, more precisely for a fine drilling process. The adjustable tool 630 is controlled by a translational movement of the control rod 270 in the example of FIG. 6. Similarly, as explained in the discussion of FIG. 5, the end of the control rod 270 and the connection part or the power transmission element 610 of the tool 630 are loosely coupled via a preloaded spring. The power transmission element 610 of the tool 630 is connected with the bolt 650. The bolt 650 is mounted in the tool 640 acting as a tightly lapped sliding core. The bolt 650 has on its front end a carbide insert 670, which acts via a sphere 675 and the pin 677 on the cutting edge 640 of the tool.

The tool cutting edge 650 of the tool 630 can be adjusted or controlled by shifting the bolt 650 via the control rod 270 in axial direction. The more the control rod 270 presses the bolt 650 via the power transmission element 610 into the tool 630 the more the tool cutting edge 640 of the fine processing tool 630 is extended. If the control rod 270 is retracted the spring assembly 655 pushes the bolt 650 against the shaft or the receiving part 635 of the tool 630. If the bolt 650 is shifted towards the receiving part 635 of the tool 630, the bending of the blanking die holder 680 is relaxed, whereby the tool cutting edge 640 of the tool 630 retracts so that the tool 630 can be retracted from the drilling hole without touching the wall of the drilling hole by the tool cutting edge 640. The blanking die holder 680 is fixed to the tool 630 with the fixing elements 660 which are screws in the example represented in the tool 630 of FIG. 6. In the tool 630 represented in FIG. 6 the diameter of the tool cutting edge 640 can be adjusted in the range of 0.4 mm to 0.7 mm. The repeatability of the diameter of the tool cutting edges 640 of the tool 630 is in the range of 10 μm.

The power transmission element 610 has a channel 650 for transmitting a fluid. The tool 630 can be cooled and/or can be lubricated by providing a respective quantity of a fluid via the openings 690 through the drilling hole 680 of the control rod 270 and the channel 650 of the power transmission element 610.

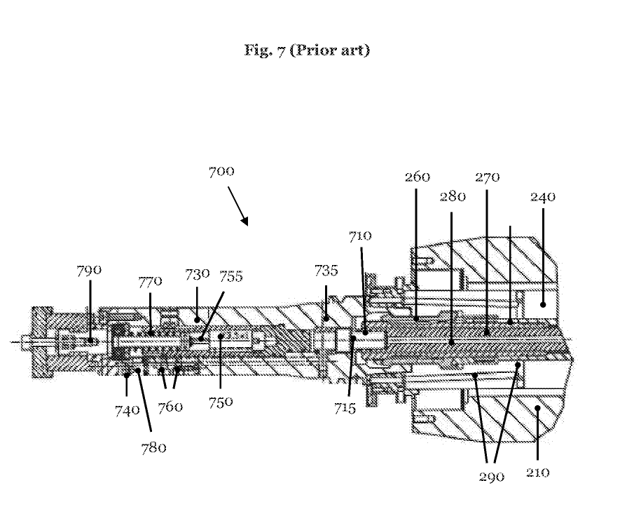

Finally, the arrangement 700 of FIG. 7 shows the A side of the motor spindle 210 on which spindle shaft 240 a second fine processing tool 730 according to the prior art is clamped. The adjustable tool 730 which is exemplary represented in FIG. 7 is a boring tool for finish boring. The power transmission element 710 has a channel 715 which is connected with the drilling hole 280 of the control rod 270. The channel 715 extends within the tool 730 up to the tool cutting edge 740. By introducing a fluid under a corresponding pressure into the rotary feed-through 330 the tool cutting edge 740 of the tool is extended in a defined manner. If the pressure is removed, the cutting edge 740 of the tool 730 retracts to the extent in the tool 730 so that the cutting edge 740 does not damage the wall of the drilling hole when the tool is retracted. The blanking die holder 780 is fixed to the tool 730 with fixing elements 760 which are also screws in the example of FIG. 7. Similar as explained in the context of the tool 630 of FIG. 6, extending and retracting the tool cutting edge 740 occurs for the tool 730 controlled by fluid or controlled by medium of FIG. 7 via material bending of the blanking die holder 780.

The tool 730 is pre-adjusted against the resistance of the spring assembly 770 via the planetary gear spindle 755, the nut screw 750 and the journal 790. To compensate the wear of the tool cutting edge 740 of the tool 730, the tool cutting edge is readjusted via the journal 790 and the planetary gear spindle 750. The repeatability of the diameter adjustment of the tool controlled by medium is in the micrometer range.

The apparatus explained in the present application allows both an automatic clamping and an automatic adjustment and setting of adjustable tools. It does not matter whether the adjustable tool is designed for a mechanical (i.e. by a translational movement of the control rod) or for a fluid controlled adjustment (i.e. by providing a fluid with a respective pressure).

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A motor spindle for a machine tool comprising:
a. a tool clamping system configured to automatically clamp and release an adjustable tool;
b. a control rod arranged within the tool clamping system; and
c. a setting unit arranged on a B side of the motor spindle which is configured to adjust the adjustable tool via the control rod.

2. The motor spindle according to claim 1, wherein the control rod comprises a drilling hole in axial direction to conduct at least one fluid through the control rod.

3. The motor spindle according to claim 2, wherein the at least one fluid comprises at least one of:
a coolant;
a gas; and
a gas mixture.

4. The motor spindle according to claim 3, wherein the gas mixture comprises at least one of air and an oil.

5. The motor spindle according to claim 1, wherein the setting unit comprises at least one electric motor and at least one worm gear.

6. The motor spindle according to claim 5, wherein the at least one worm gear comprises a planetary gear.

7. The motor spindle according to claim 5, wherein the at least one electric motor comprises an actuator, and wherein the setting unit further comprises a clutch in order to couple the at least one worm gear to the actuator.

8. The motor spindle according to one of the patent claim 5, wherein the at least one electric motor moves the control rod in axial direction via the at least one worm gear in order to adjust the adjustable tool.

9. The motor spindle according to claim 1, wherein after an electronic request of the axial position of the control rod the setting unit moves the tool-side end of the control rod with a mean deviation of less of ≦±100 μm.

10. The motor spindle according to claim 1, wherein the setting unit comprises a cooling unit.

11. The motor spindle according to claim 10, wherein the cooling unit comprises a rotary feed-through.

12. The motor spindle according to claim 10, wherein the cooling unit adjusts the controllable tools via at least one fluid conducted through the control rod.

13. The motor spindle according to claim 12, wherein the at least one fluid performs at least one of cooling and lubrication of the adjustable tool.

14. The motor spindle according claim 2, wherein an axial movement of the control rod adjusts the adjustable tool and the at least one fluid performs at least one of cooling and lubrication of the adjustable tool.

15. A method for adjusting an adjustable tool which is detachably connected to a motor spindle of a machine tool, wherein the motor spindle comprises an automatic tool clamping system and the tool clamping system comprises a control rod arranged within the automatic tool clamping system, the method comprising:
a. clamping and releasing the adjustable tool by the automatic tool clamping system; and
b. adjusting, via the control rod, the adjustable tool by a setting unit arranged on the B side of the motor spindle.

16. The method according to claim 15, wherein adjusting the adjustable tool comprises moving the control rod in axial direction.

17. The method according to claim 16, wherein moving the control rod in axial direction comprises transforming a rotational movement of a shaft of an electric motor in a translational movement of the control rod by a worm gear.

18. The method according to claim 15, wherein adjusting the adjustable tool comprises conducting a fluid through a drilling hole of the control rod in axial direction.

19. The method according to claim 15, wherein setting the adjustable tool comprises moving the control rod in axial direction, and wherein performing at least one of cooling and lubricating the adjustable tool comprises conducting a fluid through a drilling hole of the control rod in axial direction.

20. An adjustable tool comprising:
a. a receiving element adapted to detachably engage with an automatic tool clamping system; and
b. a power transmission element configured to detachably engage with a control rod arranged in the automatic tool clamping system in order to adjust the adjustable tool.

21. The adjustable tool according to claim 20, wherein the power transmission element is further configured to receive a fluid which is provided to the adjustable tool via an axial drilling hole of the control rod.

22. The adjustable tool according to claim 20, further comprising at least one spring which is configured to counteract a force exerted to the power transmission element.
